(19) United States
(12) Patent Application Publication
(10) Pub. No.: US 2008/0143987 A1
(43) Pub. Date: Jun. 19, 2008

(54) EXPOSURE APPARATUS AND DEVICE FABRICATION METHOD

(75) Inventor: Takanori Uemura, Utsunomiya-shi (JP)

Correspondence Address: MORGAN & FINNEGAN, L.L.P., 3 WORLD FINANCIAL CENTER, NEW YORK, NY, 10281-2101, US

(73) Assignee: CANON KABUSHIKI KAISHA, Tokyo (JP)

(21) Appl. No.: 11/955,705

(22) Filed: Dec. 13, 2007

(30) Foreign Application Priority Data
Dec. 15, 2006 (JP) 2006-339203

(51) Int. Cl. G03B 27/54

(52) U.S. Cl. 355/67

(57) ABSTRACT

An exposure apparatus comprises an illumination optical system configured to illuminate a reticle arranged on a surface to be illuminated with a light beam from a light source, a projection optical system configured to project a pattern of the reticle onto a substrate, and a stage configured to drive the substrate, wherein the illumination optical system includes a light distribution forming unit configured to form a trapezoidal light intensity distribution along a scanning direction of the reticle on the surface to be illuminated to uniform a light angle distribution for illuminating each point on the surface to be illuminated, and the substrate is exposed with the light intensity distribution and light angle distribution formed by the light distribution forming unit, while the stage drives the substrate by tilting a normal to the substrate with respect to an optical axis of the projection optical system.

### BACKGROUND OF THE INVENTION

1. Field of the Invention

The present invention relates to an exposure apparatus and a device fabrication method.

2. Description of the Related Art

Projection exposure apparatuses have conventionally been employed to fabricate fine semiconductor devices such as a semiconductor memory and logic circuit using photolithography (exposure). The projection exposure apparatuses each project and transfer a circuit pattern drawn on a reticle (mask) onto, for example, a wafer via a projection optical system.

The projection exposure apparatuses are mainly classified into two types, that is, a step type exposure apparatus and scan type exposure apparatus. The step type exposure apparatus is usually not expensive as compared with the scan type exposure apparatus because of its simple structure. However, the step type exposure apparatus requires increasing the exposure field of the projection optical system to expose a wide region, leading to troublesome aberration correction.

The scan type exposure apparatus executes exposure by synchronously scanning a reticle and wafer. The scan type exposure apparatus can expose a region wider than the exposure field of the projection optical system by scanning the reticle and wafer. Hence, the scan type exposure apparatus can reduce the exposure field of the projection optical system so as to facilitate aberration correction.

In recent years, exposure apparatuses use pulse light sources such as a KrF excimer laser (wavelength: about 248 nm) and an ArF excimer laser (wavelength: about 193 nm). When the scan type exposure apparatus uses a pulse light source, dose nonuniformity (exposure nonuniformity) in the scanning direction occurs on the wafer due to pulse discontinuity. To ensure a dose uniformity in the scanning direction on the reticle, in the scan type exposure apparatus, a light-shielding member is arranged at a position defocused from a plane conjugate to the reticle. The light intensity distribution becomes a trapezoidal light intensity distribution in the scanning direction on the reticle surface by the defocus of the light-shielding member. Japanese Patent Laid-Open Nos. 2001-358057, 10-92730, and 10-189431 propose techniques of transforming the light intensity distribution into a trapezoidal one using a diffractive optical element.

A resolution R of a projection exposure apparatus is given by the so-called Rayleigh equation:

R=k1(λ/NA)

where λ is the wavelength of a light source, NA is the numerical aperture of a projection optical system, and k1 is a process factor.

Referring to the Rayleigh equation, to transfer a micropattern by decreasing the resolution R, it suffices to decrease the process factor k1 or wavelength λ or increase the NA of the projection optical system. In view of this, along with the recent micropatterning of semiconductor devices, the wavelengths of light sources of exposure apparatuses are shortening and the NAs of projection optical systems are increasing.

An actual exposure apparatus requires a certain depth of focus in consideration of the curvature of a wafer, the influence of, for example, wafer steps attributed to some processes, and the thickness of the wafer itself. The depth of focus is generally given by:

(depth of focus)=k2(λ/NA²)

where k2 is a constant.

Referring to the above-described equation, the depth of focus decreases as the wavelength of a light source shortens and the NA of a projection optical system increases. This leads to deterioration in yield because the depth of focus decreases in fabricating fine semiconductor devices.

To solve this problem, there is proposed a technique of increasing the depth of focus without changing the wavelength of a light source and the NA of a projection optical system (i.e., while maintaining a shortened wavelength of the light source and an increased NA of the projection optical system) This technique is disclosed in [Proc. of SPIE Vol. 615461541K-1 “The Improvement of DOF for Sub-100 nm Process by Focus Scan” (to be referred to as reference 1 hereinafter)]. Reference 1 discloses a method of scanning a wafer while the normal to the wafer is tilted with respect to the optical axis of the projection optical system. As the wafer is scanned while the normal to the wafer is tilted with respect to the optical axis, the wafer is exposed on a number of focal planes. This makes it possible to practically increase the depth of focus.

However, in prior art, when a wafer is exposed using exposure light having a trapezoidal light intensity distribution while being scanned in a state wherein the normal to the wafer is tilted with respect to the optical axis, the pattern (pattern image) of a reticle to be transferred onto the wafer shifts.

The reason why the pattern image shifts on the wafer will be explained in detail with reference to FIGS. 10A to 10C. As shown in FIGS. 10A to 10C, the optical axis direction of a projection optical system is defined as the Z-axis, the scanning direction of a wafer when the tilt of the normal to the wafer with respect to the optical axis is zero is defined as the Y-axis, and a direction perpendicular to the Y- and Z-axes is defined as the X-axis. The resultant coordinate system will be used in the following description unless otherwise specified.

FIG. 10A illustrates a case wherein a light-shielding member is arranged at a position defocused from a reticle surface (surface to be illuminated) or a plane conjugate to it to form a trapezoidal light intensity distribution. The following description also applies to, for example, a case wherein a light-shielding member is arranged at a position where the exit surface of a rod integrator is defocused from the surface to be illuminated (illumination target surface).

By arranging a light-shielding member at a position defocused from the illumination target surface, a trapezoidal light intensity distribution is formed on the illumination target surface, as shown in FIG. 10B. Note that the light angle distribution on the illumination target surface is nonuniform because the light-shielding member partially shields the light beam, as shown in FIG. 10A. For example, the light angle distributions at points A and C shown in FIG. 10A exhibit mirror images. Referring to FIGS. 10A and 10B, a point B lies on the optical axis and the points A and C lie on the oblique sides of the trapezoidal light intensity distribution.

In normal scanning exposure which does not tilt the normal to a wafer with respect to the optical axis, the light angle distributions at the points A and C add up upon scanning the wafer. The overall light angle distribution is nearly equal to the light angle distribution at the point B, so a pattern image to be transferred onto the wafer does not shift.

When a wafer is scanned while the normal to the wafer is tilted with respect to the optical axis, a pattern image to be transferred onto the wafer shifts, as described above. For example, as shown in FIG. 10C, consider a case wherein a wafer is scanned while being tilted such that the defocus (tilt) is in the minus direction on its upper side with respect to the Z-axis while it is in the plus direction on its lower side with respect to the Z-axis.

A barycentric ray which illuminates a given point on the illumination target surface is defined as a ray in the direction of an angle θg calculated by:

$$θ g = \frac{\int θ \cdot I ( θ ) d θ}{\int I ( θ ) d θ} \qquad ( 1 )$$

where θ is the angle of the ray with respect to the optical axis, and I(θ) is the light intensity at a given angle θ, as shown in FIG. 11C. That is, the barycentric ray indicates a direction corresponding to the center of gravity of the angle distribution of an incident light beam. As shown in FIG. 10A, a barycentric ray points upward in the upper region while it points downward in the lower region. As shown in FIG. 10C, in the upper region, since the defocus is in the minus direction, the intersection between the barycentric ray and the wafer shifts in the minus direction of the Y-axis as compared with a case wherein the wafer is not tilted. Likewise, in the lower region, since the defocus is in the plus direction, the intersection between the barycentric ray and the wafer shifts in the minus direction of the Y-axis as compared with a case wherein the wafer is not tilted.

In this manner, since the intersection between the barycentric ray and the wafer shifts in the minus direction of the Y-axis both in the upper and lower regions, the respective shifts add up upon scanning the wafer. This leads to a shift in a pattern image to be transferred onto the wafer.

Careful examinations by the inventors of the present invention reveal that, when the conventional exposure apparatuses expose a wafer while scanning it in an oblique direction with respect to the optical axis, the shape of the pattern image is disturbed as if the projection optical system generated coma aberration.

### SUMMARY OF THE INVENTION

The present invention provides an exposure apparatus which can obtain a favorable pattern image even though the depth of focus is increased by scanning a substrate while the normal to the substrate is tilted with respect to the optical axis.

According to one aspect of the present invention, there is provided an exposure apparatus comprising an illumination optical system configured to illuminate a reticle arranged on a surface to be illuminated with a light beam from a light source, a projection optical system configured to project a pattern of the reticle onto a substrate, and a stage configured to drive the substrate, wherein the illumination optical system includes a light distribution forming unit configured to form a trapezoidal light intensity distribution along a scanning direction of the reticle on the surface to be illuminated to uniform a light angle distribution for illuminating each point on the surface to be illuminated, and the substrate is exposed with the light intensity distribution and light angle distribution formed by the light distribution forming unit, while the stage drives the substrate by tilting a normal to the substrate with respect to an optical axis of the projection optical system.

According to another aspect of the present invention, there is provided a device fabrication method comprising steps of exposing a substrate using the above exposure apparatus, and performing a development process for the substrate exposed.

Further features of the present invention will become apparent from the following description of exemplary embodiments with reference to the attached drawings.

### BRIEF DESCRIPTION OF THE DRAWINGS

FIG. 1 is a schematic sectional view of an exposure apparatus according to one aspect of the present invention.

FIGS. 2A and 2B are an enlarged sectional view and diagram of the vicinity of a condenser lens, light-shielding members, and a CGH serving as a light distribution forming unit of the exposure apparatus shown in FIG. 1.

FIG. 3 is a schematic sectional view of an exposure apparatus according to one aspect of the present invention.

FIGS. 4A and 4B are enlarged sectional views and diagrams of the vicinity of a condenser lens and a lens array serving as a light distribution forming unit of the exposure apparatus shown in FIG. 3.

FIGS. 5A and 5B are an enlarged sectional view and diagram of the vicinity of the condenser lens and the lens array serving as the light distribution forming unit of the exposure apparatus shown in FIG. 3.

FIGS. 6A and 6B are an enlarged sectional view and diagram of the vicinity of the condenser lens and the lens array serving as the light distribution forming unit of the exposure apparatus shown in FIG. 3.

FIGS. 7A and 7B are views for explaining the influence on the light angle distribution when the condenser lens generates aberration.

FIG. 8 is a flowchart for explaining a method for fabricating devices.

FIG. 9 is a detail flowchart of a wafer process in Step 4 of FIG. 8.

FIGS. 10A to 10C are views for explaining the reason why a pattern image shifts when a wafer is exposed using exposure light having a trapezoidal light intensity distribution while being scanned in a state wherein the normal to the wafer is tilted with respect to the optical axis.

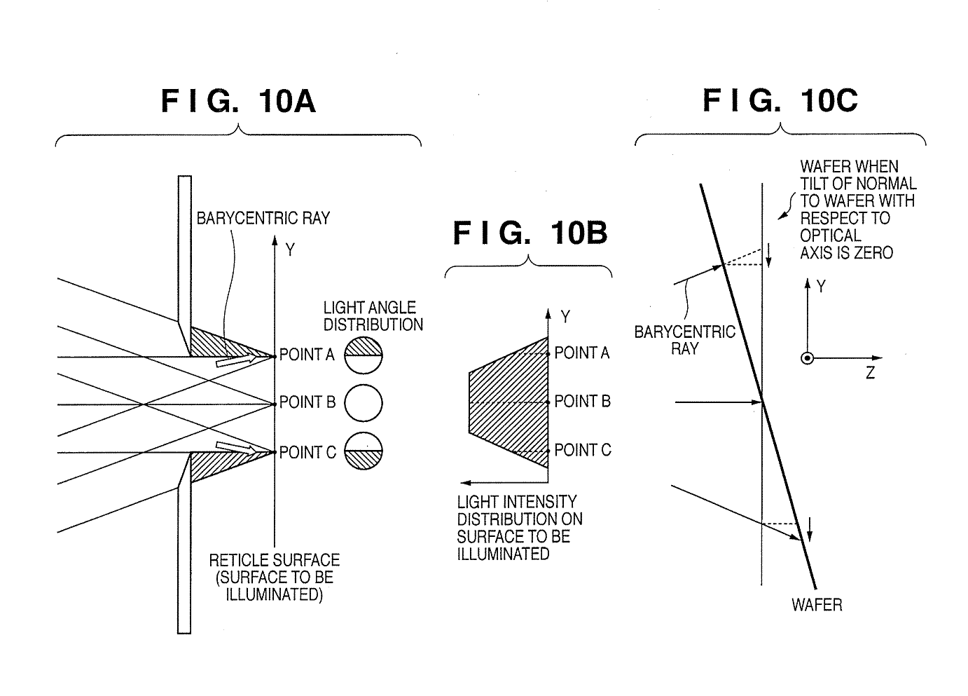

FIGS. 11A and 11B are views for explaining a barycentric ray.

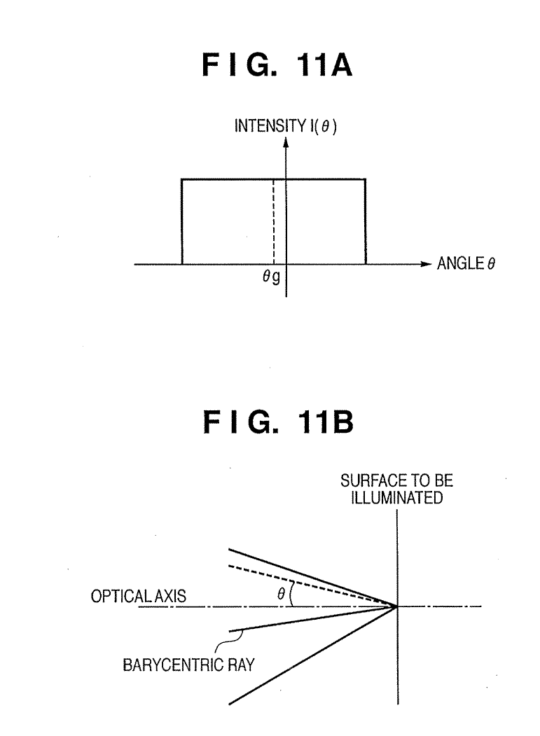

### DESCRIPTION OF THE EMBODIMENT

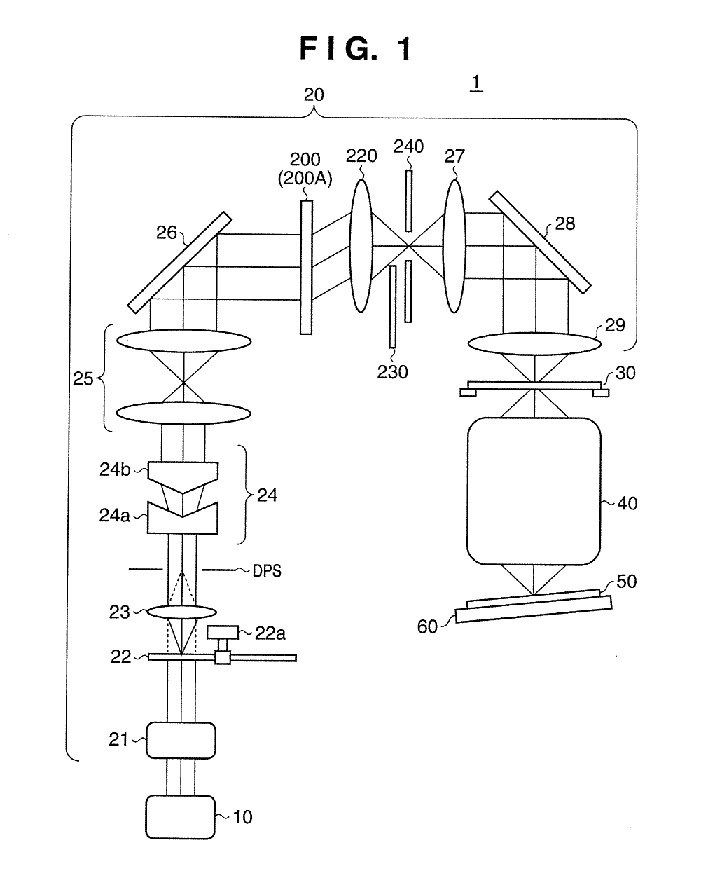

With reference to the accompanying drawings, a description will now be given of an exposure apparatus of one embodiment according to the present invention. The same reference numeral in each figure denotes the same element, and a duplicate description thereof will be omitted. Here, FIG. 1 is a schematic sectional view of an exposure apparatus according to the present invention.

An exposure apparatus 1 is a scan type (scanning) exposure apparatus which transfers the pattern of a reticle 30 onto a wafer 50 by exposure in a step-and-scan manner. As shown in FIG. 1, the exposure apparatus 1 includes an illumination apparatus, a reticle stage which mounts the reticle 30, a projection optical system 40, and a wafer stage 60 which mounts the wafer 50.

The illumination apparatus includes a light source unit 10 and illumination optical system 20, and illuminates the reticle 30 on which a circuit pattern to be transferred is formed.

The light source unit 10 uses, for example, an ArF excimer laser having a wavelength of about 193 nm or a KrF excimer laser having a wavelength of about 248 nm. However, the type and wavelength of the light source of the light source unit 10 are not particularly limited, and the number of light sources of the light source unit 10 is not particularly limited, either.

The illumination optical system 20 illuminates the reticle 30 arranged on an illumination target surface. In this embodiment, the illumination optical system 20 includes a relay optical system 21, diffractive optical element 22, condenser lens 23, prism 24, zoom lens 25, mirror 26, light distribution forming unit 200, condenser lens 220, light-shielding members 230 and 240, condenser lens 27, mirror 28, and collimator lens 29.

The relay optical system 21 guides a light beam from the light source unit 10 to the diffractive optical element 22.

The diffractive optical element 22 is mounted on, for example, a turret having a plurality of slots. An actuator 22a drives the turret so that an arbitrary diffractive optical element 22 is inserted into the optical path (optical axis).

The condenser lens 23 condenses the light beam emerging from the diffractive optical element 22 to form a diffraction pattern on a diffraction pattern surface DPS. When the actuator 22a switches between diffractive optical elements 22 to be inserted into the optical axis, it is possible to change a diffraction pattern to be formed on the diffraction pattern surface DPS. The diffraction pattern formed on the diffraction pattern surface DPS undergoes the adjustment of parameters such as the annular ratio or the σ value (coherency) via the prism 24 and zoom lens 25, and enters the mirror 26.

The prism 24 includes optical elements 24a and 24b. The optical element 24a has a flat incidence surface and a conical concave exit surface. The optical element 24b has a conical convex incidence surface and a flat exit surface. The prism 24 adjusts the annular ratio by changing the distance between the optical elements 24a and 24b. When the distance between the optical elements 24a and 24b is sufficiently short, it is possible to regard them as one parallel glass plate. In this case, the diffraction pattern formed on the diffraction pattern surface DPS is guided to the light distribution forming unit 200 via the zoom lens 25 and mirror 26 while maintaining a roughly similar figure. The annular ratio and center angle of the diffraction pattern formed on the diffraction pattern surface DPS are adjusted by increasing the distance between the optical elements 24a and 24b.

The zoom lens 25 has a function of enlarging or reducing the light beam from the prism 24 to adjust the σ value.

The mirror 26 is arranged to have a predetermined tilt with respect to an incident light beam. The mirror 26 reflects the light beam from the zoom lens 25 to guide it to the light distribution forming unit 200.

The light distribution forming unit 200 forms a light intensity distribution (to be referred to as a “trapezoidal light intensity distribution” hereinafter) along the scanning direction on the reticle 30 (illumination target surface) to have a trapezoidal shape. The light distribution forming unit 200 also has a function of uniforming a light angle distribution for illuminating each point on the reticle 30 as the illumination target surface. In this embodiment, the light distribution forming unit 200 includes a CGH (Computer Generated Hologram) 200A. The CGH 200A is a diffractive optical element in which a pattern designed to obtain a desired diffraction distribution (i.e., a trapezoidal light intensity distribution) by a computer is formed on a substrate. The CGH 200A is preferably designed such that diffracted light forms a light intensity distribution at a position that falls outside the original optical axis (that of the preceding optical system). With this design, the light-shielding member 230 can shield a light beam component (0th-order light beam component), which is transmitted at the same angle as the incidence angle without being diffracted by the CGH 200A, of the light beam that enters the CGH 200A. However, if the CGH 200A is ideally manufactured to the degree that it generates no 0th-order light beam component, it is unnecessary to design the CGH 200A such that diffracted light forms a light intensity distribution at a position that falls outside the original optical axis. The CGH 200A serving as the light distribution forming unit 200 will be explained in detail later.

The condenser lens 220 functions as a condensing optical system which condenses the light beam emerging from the light distribution forming unit 200. The condenser lens 220 illuminates a illumination target surface matching the position of the light-shielding member 240, with the trapezoidal light intensity distribution formed by the light distribution forming unit 200.

When the light distribution forming unit 200 uses the CGH 200A, the light-shielding member 230 is interposed between the condenser lens 220 and the light-shielding member 240, and shields the light beam component (0th-order light beam component) transmitted without being diffracted by the CGH 200A. In other words, the light-shielding member 230 has a function of preventing the 0th-order light beam component from the CGH 200A from reaching the reticle 30 as the illumination target surface. However, as described above, when the CGH 200A generates no 0th-order light beam component, the light-shielding member 230 need not always be provided.

The light-shielding member 240 is arranged on a plane (a plane conjugate to the illumination target surface) conjugate to the reticle 30, and defines the illumination area of the reticle 30. The light-shielding member 240 is scanned in synchronism with the reticle 30 and the wafer 50 supported by the wafer stage 60. The light-shielding member 240 also has the function of the light-shielding member 230, that is, can also be used as the light-shielding member 230. In this case, the light-shielding member 240 has a function of defining the illumination area of the reticle 30 and a function of shielding the light beam component (0th-order light beam component) transmitted without being diffracted by the CGH 200A.

The condenser lens 27 guides the light beam having passed through the light-shielding member 240 to the collimator lens 29.

The mirror 28 is arranged to have a predetermined tilt with respect to an incident light beam. The mirror 28 reflects the light beam from the condenser lens 27 to guide it to the collimator lens 29.

The collimator lens 29 illuminates the reticle 30 as the illumination target surface with the light beam which is emerging from the condenser lens 27 and is reflected by the mirror 28.

The reticle 30 has a circuit pattern and is supported by the reticle stage. The reticle stage scans the reticle 30 in a predetermined scanning direction. Diffracted light generated by the reticle 30 is projected onto the wafer 50 via the projection optical system 40. Since the exposure apparatus 1 is a scan type exposure apparatus, it transfers the pattern of the reticle 30 onto the wafer 50 by scanning the reticle 30 and wafer 50 at a speed ratio matching the reduction magnification ratio of the projection optical system 40.

The projection optical system 40 projects the pattern of the reticle 30 onto the wafer 50. The projection optical system 40 can use a dioptric system including a plurality of lens elements alone, a catadioptric system including a plurality of lens elements and at least one concave mirror, or a catoptric system of a total reflection mirror type.

The wafer 50 is supported and driven by the wafer stage 60. In another embodiment, the wafer 50 broadly includes a glass plate and others. The wafer 50 is coated with a photoresist.

The wafer stage 60 holds and drives the wafer 50 using, for example, a linear motor. The wafer stage 60 has a mechanism which can tilt the wafer 50 with respect to the optical axis. In other words, the wafer stage 60 scans the wafer 50 while the normal to the wafer 50 is tilted with respect to the optical axis. This makes it possible to increase the depth of focus.

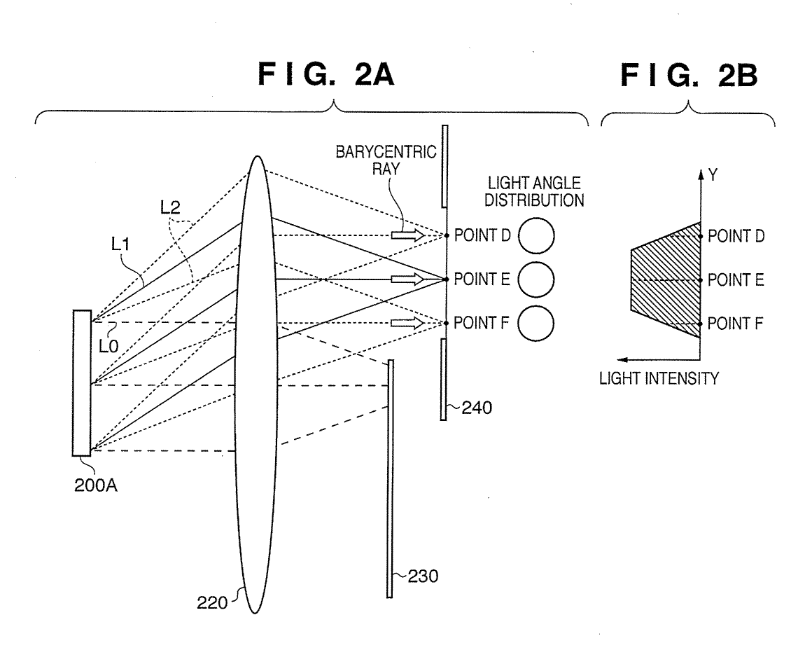

The CGH 200A serving as the light distribution forming unit 200 will be explained in detail here with reference to FIGS. 2A and 2B. FIGS. 2A and 2B are an enlarged sectional view and diagram of the vicinity of the CGH 200A, condenser lens 220, and light-shielding members 230 and 240.

As shown in FIG. 2B, the CGH 200A according to this embodiment is a diffractive optical element designed to form a trapezoidal light intensity distribution on the light-shielding member 240 (the plane conjugate to the reticle 30). In this embodiment, the illumination target surface (reticle 30) is roughly conjugate to the Fourier transform plane.

Referring to FIG. 2A, sparsely dotted lines indicate 0th-order light beam components L0, solid lines indicate light beam components L1 which illuminate a point E matching the flat side of the trapezoidal light intensity distribution, and densely dotted lines indicate light beam components L2 which illuminate points D and F matching the oblique sides of the trapezoidal light intensity distribution.

Referring to FIG. 2A, the 0th-order light beam components L0 are shielded by the light-shielding member 230. On the other hand, the light beam components L1 and L2 are not shielded by the light-shielding member 230 and illuminate the light-shielding member 240 (the plane conjugate to the reticle 30) with the trapezoidal light intensity distribution.

In this embodiment, as shown in FIG. 2A, the trapezoidal light intensity distribution is not formed by defocusing the light-shielding member 240 from the plane conjugate to the reticle 30 (illumination target surface). For this reason, barycentric ray become roughly parallel to the optical axis even at the points D and F matching the oblique sides of the trapezoidal light intensity distribution. In addition, the light angle distribution on the light-shielding member 240 (the plane conjugate to the reticle 30), that is, the light angle distribution at each of the points D to F becomes uniform irrespective of the light intensity distribution in the scanning direction (Y-axis direction) of the reticle 30. In other words, the light beam emerging from the CGH 200A strikes the reticle 30 or the plane conjugate to it such that a light angle distribution for illuminating each point on the reticle 30 or the plane conjugate it becomes uniform.

Even when the exposure apparatus 1 exposes the wafer 50 while scanning it in a state wherein the normal to the wafer 50 is tilted with respect to the optical axis, the pattern (pattern image) of the reticle 30 to be transferred onto the wafer 50 never shifts. Still better, the exposure apparatus 1 can prevent (suppress) the shape of the pattern image from being disturbed as if the projection optical system generated coma aberration. Consequently, the exposure apparatus 1 can obtain a favorable pattern image even though the depth of focus increases, thus attaining an excellent exposure performance.

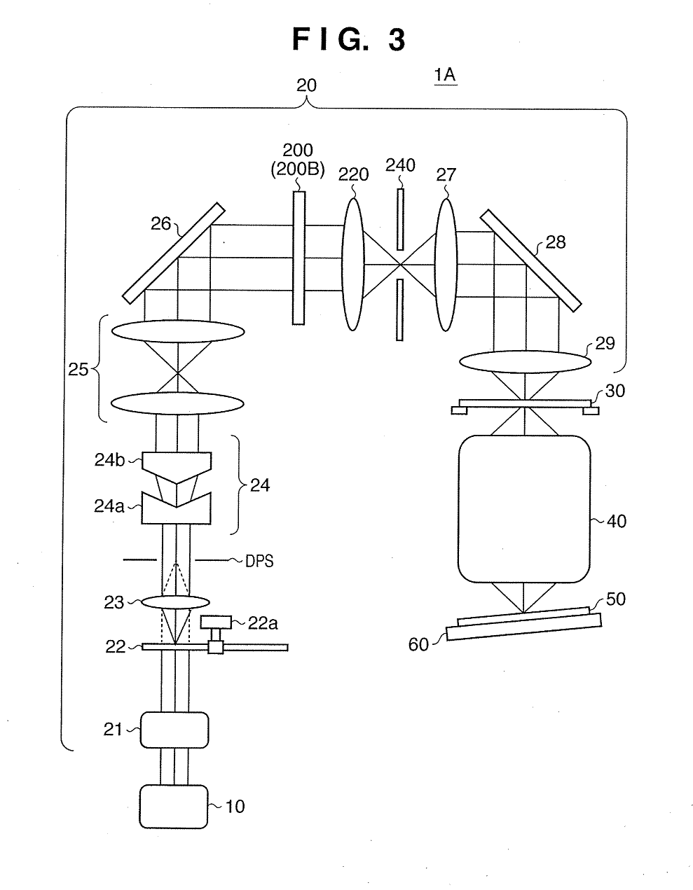

An exposure apparatus 1A as a modification to the exposure apparatus 1 will be explained below with reference to FIGS. 3 to 6A and B. FIG. 3 is a schematic sectional view of the arrangement of the exposure apparatus 1A. The exposure apparatus 1A is different from the exposure apparatus 1 in using a lens array 200B as the light distribution forming unit 200. When the light distribution forming unit 200 uses the lens array 200B, it is unnecessary to form a light intensity distribution at a position that falls outside the original optical axis in consideration of the generation of a 0th-order light beam component, unlike the CGH 200A. It is also unnecessary to provide the light-shielding member 230 for shielding a 0th-order light beam component.

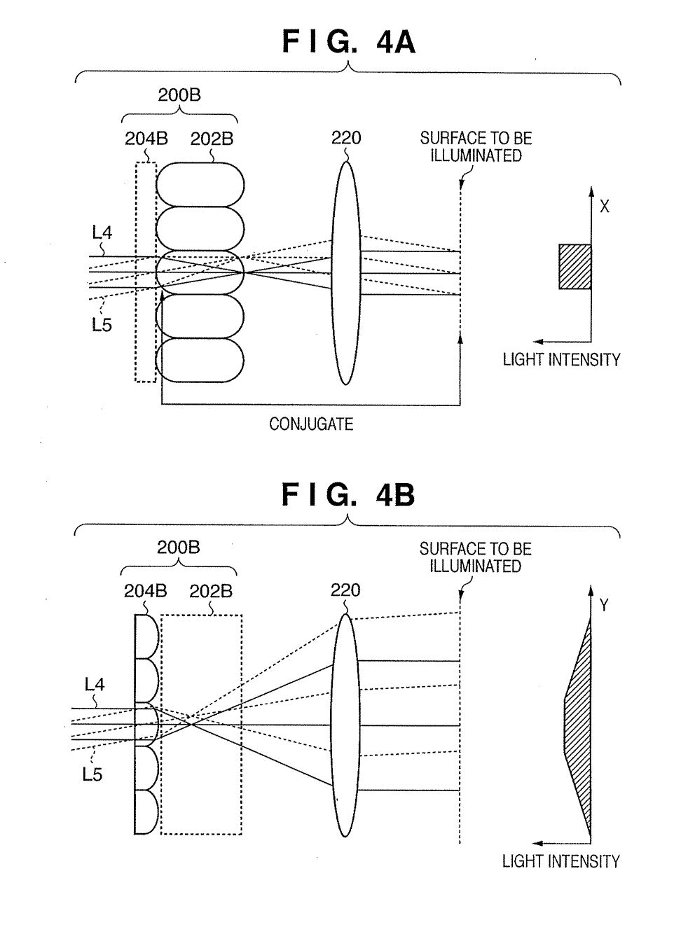

FIGS. 4A and 4B are enlarged sectional views and diagrams of the vicinity of the lens array 200B and condenser lens 220. Referring to FIGS. 4A and 4B, solid lines indicate light beam components L4 which enter the lens array 200B parallel to the optical axis, and broken lines indicate light beam components L5 which enter the lens array 200B while being tilted with respect to the optical axis. FIG. 4A is a sectional view of an optical system (including the lens array 200B and condenser lens 220), which is taken along a plane including the optical axis and the X-axis perpendicular to the scanning direction (Y-axis direction) of the reticle 30. FIG. 4B is a sectional view of the optical system (including the lens array 200B and condenser lens 220), which is taken along a plane including the optical axis and the Y-axis along the scanning direction of the reticle 30.

In this embodiment, the lens array 200B includes a first lens array 202B and second lens array 204B. The first lens array 202B has a refractive power only in a direction (X-axis direction) perpendicular to the scanning direction of the reticle 30. The second lens array 204B has a refractive power only in the scanning direction (Y-axis direction) of the reticle 30. Referring to FIG. 4A, dotted lines indicate light beam components refracted by the second lens array 204B having a refractive power in the Y-axis direction (i.e., not having a refractive power in the X-axis direction). Likewise, referring to FIG. 4B, dotted lines indicate light beam components refracted by the first lens array 202B having a refractive power in the X-axis direction (i.e., not having a refractive index in the Y-axis direction).

Although the illumination area in the Y-axis direction is wider than that in the X-axis direction in FIGS. 4A and 4B for the illustrative convenience, the illumination area in the X-axis direction is generally wider than that in the Y-axis direction. However, the present invention does not particularly limit the illumination areas in the X- and Y-axis directions. When the exposure apparatus 1 includes the mirror 28 as shown in FIG. 1, the scanning direction of the reticle 30 with respect to the lens array corresponds to a direction which considers a return trip by the mirror. More specifically, although the scanning direction of the reticle 30 is the horizontal direction in FIG. 1, the scanning direction of the reticle 30 with respect to the lens array corresponds to the vertical direction.

In a normal exposure apparatus, the exposure field of a projection optical system has a dimension equal to the width, in the X-axis direction, of a pattern to be transferred to a wafer. The edge of the light intensity distribution in the X-axis direction on an illumination target surface (reticle) is preferably sharp. This is in contrast to the fact that a trapezoidal light intensity distribution in the scanning direction of the reticle is required to avoid generating a variation in dose in the scanning direction of the wafer.

In this embodiment, to sharpen the edge of the light intensity distribution in the X-axis direction, the incidence surfaces of lenses which constitute the first lens array 202B are made conjugate to the illumination target surface (reticle 30), as shown in FIG. 4A. The condenser lens 220 condenses light beam components emerging from the lenses which constitute the first lens array 202B to illuminate the illumination target surface while superposing them. This makes the light illumination distribution in the X-axis direction on the illumination target surface roughly uniform.

As shown in FIG. 4B, to illuminate the illumination target surface (reticle 30) with a trapezoidal light intensity distribution in the Y-axis direction, the incidence surfaces of lenses which constitute the second lens array 204B are not completely made conjugate to the illumination target surface. In other words, the second lens array 204B is arranged at a position shifted from the plane conjugate to the illumination target surface (a plane in which the reticle 30 is arranged). An illumination area on the illumination target surface shifts by the light beam components L4 which enter the second lens array 204B parallel to the optical axis and by the light beam components L5 which enter the second lens array 204B while being tilted with respect to the optical axis.

A trapezoidal light intensity distribution is formed on the illumination target surface by superposing the illumination area shifted depending on the incidence angle. The ratio of the oblique side to the flat side of the trapezoid depends on the light beam incidence angle with respect to the lens array 200B. By changing the focal length of the first lens array 202B to adjust the degree of conjugation between the incidence surface of the first lens array 202B and the illumination target surface, the ratio of the oblique side to the flat side of the trapezoid can be changed.

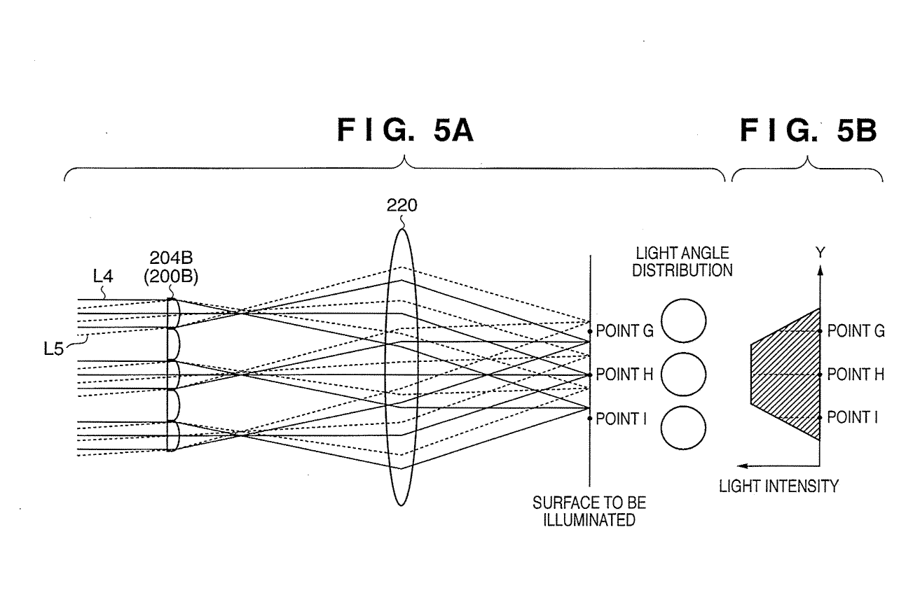

The light angle distribution at each point on a trapezoidal light intensity distribution formed on the illumination target surface (reticle 30) by the lens array 200B (first lens array 202B) will be explained with reference to FIGS. 5A and 5B.

Assume that the incidence surfaces of the lenses which constitute the first lens array 202B are not completely conjugate to the illumination target surface. In this case, as described above, the illumination area on the illumination target surface shifts depending on the light beam incidence angle with respect to the first lens array 202B. When this occurs, a trapezoidal light intensity distribution is formed on the illumination target surface, as shown in FIG. 5B.

Also as shown in FIG. 5A, even a light beam which enters the first lens array 202B while being tilted with respect to the optical axis is not shielded and illuminates the illumination target surface. For this reason, barycentric ray become roughly parallel to the optical axis at a point H matching the flat side of the trapezoidal light intensity distribution and points G and I matching the oblique sides of the trapezoidal light intensity distribution. In addition, the light angle distribution on the illumination target surface (reticle 30), that is, the light angle distribution at each of the points G to I becomes uniform irrespective of the light intensity distribution in the scanning direction (Y-axis direction) of the reticle 30. In other words, the light beam emerging from the lens array 200B strikes the reticle 30 such that a light angle distribution for illuminating each point on the reticle 30 becomes uniform.

Even when the exposure apparatus 1A exposes the wafer 50 while scanning it in a state wherein the normal to the wafer 50 is tilted with respect to the optical axis, the pattern (pattern image) of the reticle 30 to be transferred onto the wafer 50 never shifts. Still better, the exposure apparatus 1A can prevent (suppress) the shape of the pattern image from being disturbed as if the projection optical system generated coma aberration. Consequently, the exposure apparatus 1A can obtain a favorable pattern image even though the depth of focus increases, thus attaining excellent exposure performance.

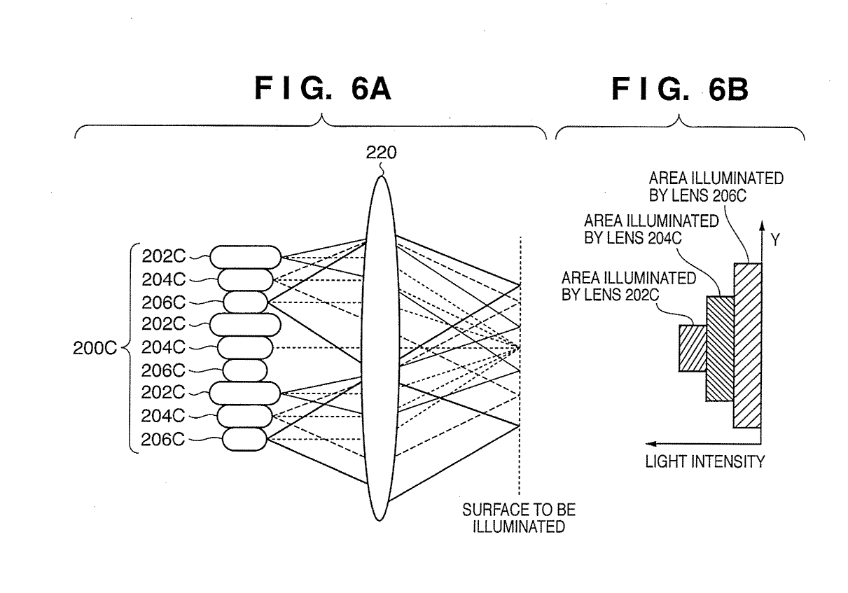

The exposure apparatus 1A can also use a lens array 200C shown in FIGS. 6A and 6B as the light distribution forming unit 200. FIGS. 6A and 6B are an enlarged sectional view and diagram of the vicinity of the lens array 200C and condenser lens 220.

The lens array 200C includes a plurality of optical elements which illuminate different illumination areas on the reticle 30 (irradiation surface). The lens array 200C according to this embodiment includes a plurality of combinations of three types of lenses 202C to 206C having different light beam exit angles. For the sake of simplicity, the lens array 200C includes three types of lenses here. In practice, however, the lens array 200C is preferably formed by combining a larger number of types of lenses.

The condenser lens 220 condenses the light beam components emerging from the three types of lenses 202C to 206C which constitute the lens array 200C to illuminate the illumination target surface while superposing them. Since the three types of lenses 202C to 206C have different exit angles, they illuminate different illumination areas in the Y-axis direction, as shown in FIG. 6B. Accordingly, the light distribution forming unit 200 including the three types of lenses 202C to 206C illuminates the illumination target surface with a stepped light intensity distribution, as shown in FIG. 6B. The step height is reduced by increasing the number of types of lenses which constitute the lens array 200C, thus forming a trapezoidal light intensity distribution on the illumination target surface.

Since the lens array 200C neither shields a light beam nor blurs a sharp-edged distribution by defocusing, the light angle distribution on the illumination target surface (reticle 30) becomes uniform irrespective of the light intensity distribution in the scanning direction (Y-axis direction) of the reticle 30. In other words, the light beam emerging from the lens array 200C strikes the reticle 30 such that a light angle distribution for illuminating each point on the reticle 30 becomes uniform.

Even when a stepped light intensity distribution is thus formed in the scanning direction (Y-axis direction) of the reticle 30, it is preferable to form a light intensity distribution having a sharp edge in the X-axis direction. For this purpose, it suffices to combine a lens array including a plurality of lenses having different exit angles and a refractive power only in the scanning direction (Y-axis direction) of the reticle 30, and a lens array including a plurality of lenses having nearly equal exit angles and a refractive power only in the X-axis direction. Alternatively, an optical element including a lens array having a front surface with a refractive power only in the X-axis direction and a back surface with that only in the Y-axis direction may be used.

In the above description, the condenser lens 220 which condenses the light beam emerging from the light distribution forming unit 200 is assumed as an ideal lens which generates no aberration. Next, the influence on the light angle distribution when the condenser lens 220 generates aberration will be explained.

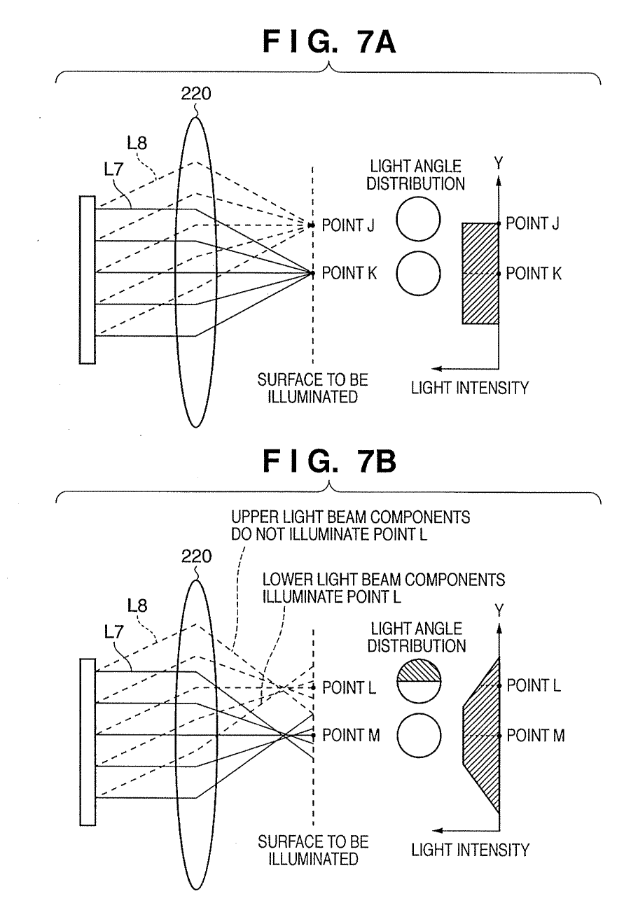

FIGS. 7A and 7B are enlarged sectional views and diagrams for explaining the influence on the light angle distribution when the condenser lens 220 generates aberration. FIG. 7A shows a case wherein the condenser lens 220 generates no aberration. FIG. 7B shows a case wherein the condenser lens 220 generates aberration. Referring to FIGS. 7A and 7B, solid lines indicate light beam components which enter the condenser lens 220 parallel to the optical axis, and broken lines indicate light beam components L8 which enter the condenser lens 220 while being tilted with respect to the optical axis. In order to focus on the influence of the aberration of the condenser lens 220, a case wherein a rectangular light intensity distribution is formed on the illumination target surface when the condenser lens 220 generates no aberration will be exemplified here.

As shown in FIG. 7A, when the condenser lens 220 generates no aberration, a rectangular flat light intensity distribution is formed on the illumination target surface. A light beam reaches and illuminates each of points J and K on the illumination target surface with its upper and light beam components. For this reason, a uniform light angle distribution is obtained at each point (e.g., each of the points J and K) on the illumination target surface, where the light beam reaches.

As shown in FIG. 7B, when the condenser lens 220 suffers a residual aberration, a trapezoidal light intensity distribution formed on the illumination target surface reflects the spot diameter determined by the aberration of the condenser lens 220. A point M matching the flat side of the trapezoidal light intensity distribution is illuminated with upper and lower light beam components. For this reason, a uniform light angle distribution is obtained at the point M.

However, upper light beam components do not reach a point L matching the oblique side of the trapezoidal light intensity distribution (i.e., the point L is not illuminated with the upper light beam components). For this reason, as shown in FIG. 7B, a nonuniform light angle distribution is obtained at the point L.

As described above, when the wafer 50 is exposed while being scanned in a state wherein the normal to the wafer 50 is tilted with respect to the optical axis, it is undesirable to form a nonuniform light angle distribution on the illumination target surface. The result of study by the inventors of the present invention reveals that the spot diameter determined by the aberration of the condenser lens 220 is preferably (α−β)/2 or less, where α and β are the upper and lower sides of a trapezoidal light intensity distribution formed by the light distribution forming unit 200. The spot diameter determined by the aberration of the condenser lens 220 is more preferably (α−β)/4 or less. Even when the condenser lens 220 suffers a residual aberration, satisfying the above-described condition makes it possible to prevent a pattern image shift and shape deterioration as if the projection optical system generated coma aberration.

In exposure, a light beam emitted by the light source unit 10 illuminates the reticle 30 via the illumination optical system 20. The pattern of the reticle 30 forms an image on the wafer 50 via the projection optical system 40. Using exposure light having a trapezoidal light intensity distribution on the reticle 30, the exposure apparatus 1 or 1A transfers the pattern of the reticle 30 onto the wafer 50 by exposure while scanning it in a state wherein the normal to the wafer 50 is tilted with respect to the optical axis. The light distribution forming unit 200 irradiates the reticle 30 such that a light angle distribution for illuminating each point on the reticle 30 becomes uniform. Hence, the exposure apparatus 1 or 1A can obtain a favorable pattern image even though the depth of focus increases. Consequently, the exposure apparatus 1 or 1A can provide devices (e.g., a semiconductor device, an LCD device, an image sensing device (e.g., a CCD), and a thin-film magnetic head) with a high throughput, good economical efficiency, and high quality.

In the above embodiment, the above embodiment indicates the conventional illumination that has the uniform light angular distribution to clear the description. However, the present invention is applicable to other various modified illuminations, such as an annular illumination and a dipole illumination.

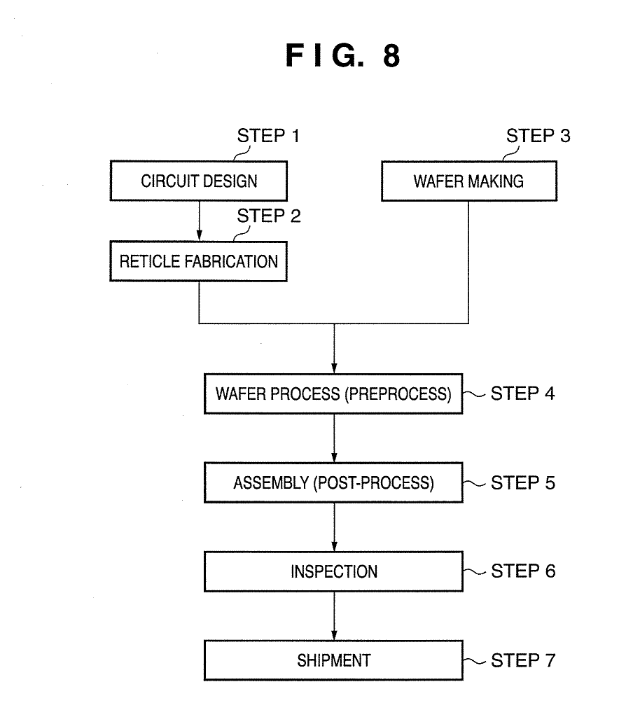

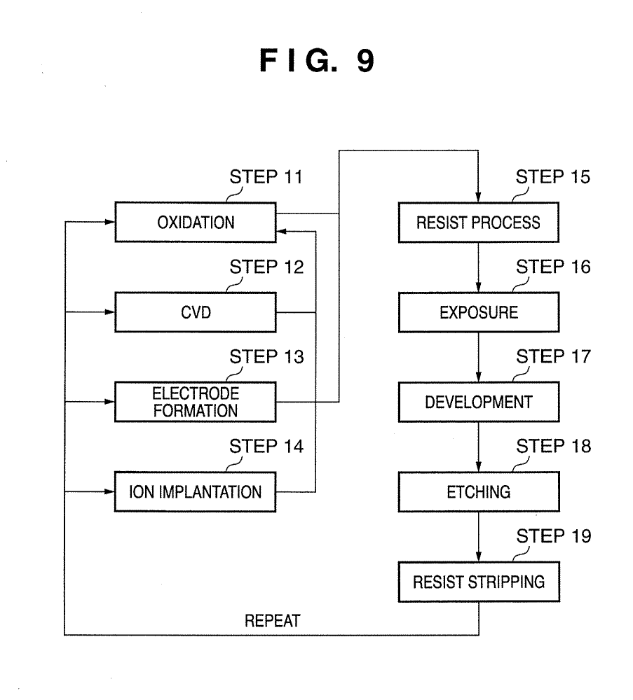

Referring now to FIGS. 8 and 9, a description will be given of an embodiment of a device fabrication method using the above mentioned exposure apparatus 1 or 1A. FIG. 9 is a flowchart for explaining how to fabricate devices (i.e., semiconductor chips such as IC and LSI, LCDs, CCDs, and the like). Here, a description will be given of the fabrication of a semiconductor chip as an example. Step 1 (circuit design) designs a semiconductor device circuit. Step 2 (reticle fabrication) forms a reticle having a designed circuit pattern. Step 3 (wafer making) manufactures a wafer using materials such as silicon. Step 4 (wafer process), which is also referred to as a pretreatment, forms the actual circuitry on the wafer through lithography using the reticle and wafer. Step 5 (assembly), which is also referred to as a post-treatment, forms into a semiconductor chip the wafer formed in Step 4 and includes an assembly step (e.g., dicing, bonding), a packaging step (chip sealing), and the like. Step 6 (inspection) performs various tests on the semiconductor device made in Step 5, such as a validity test and a durability test. Through these steps, a semiconductor device is finished and shipped (Step 7).

FIG. 9 is a detailed flowchart of the wafer process in Step 4. Step 11 (oxidation) oxidizes the wafer's surface. Step 12 (CVD) forms an insulating layer on the wafer's surface. Step 13 (electrode formation) forms electrodes on the wafer by vapor disposition and the like. Step 14 (ion implantation) implants ions into the wafer. Step 15 (resist process) applies a photosensitive material onto the wafer. Step 16 (exposure) uses the exposure apparatus 1 or 1A to expose a circuit pattern from the reticle onto the wafer. Step 17 (development) develops the exposed wafer. Step 18 (etching) etches parts other than a developed resist image. Step 19 (resist stripping) removes unused resist after etching. These steps are repeated to form multi-layer circuit patterns on the wafer. The device fabrication method of this embodiment may manufacture higher quality devices than the conventional one. Thus, the device fabrication method using the exposure apparatus 1 or 1A, and resultant devices constitute one aspect of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese application No. 2006-339203 filed on Dec. 15, 2006, which is hereby incorporated by reference herein in its entirely.

What is claimed is:

1. An exposure apparatus comprising:
an illumination optical system configured to illuminate a reticle arranged on a surface to be illuminated with a light beam from a light source;
a projection optical system configured to project a pattern of the reticle onto a substrate; and
a stage configured to drive the substrate,
wherein said illumination optical system includes a light distribution forming unit configured to form a trapezoidal light intensity distribution along a scanning direction of the reticle on the surface to be illuminated to uniform a light angle distribution for illuminating each point on the surface to be illuminated, and
the substrate is exposed with the light intensity distribution and light angle distribution formed by said light distribution forming unit, while said stage drives the substrate by tilting a normal to the substrate with respect to an optical axis of said projection optical system.

2. The apparatus according to claim 1, wherein said light distribution forming unit includes a computer generated hologram.

3. The apparatus according to claim 2, wherein said illumination optical system includes a light-shielding member configured to define an illumination area on the reticle, and shield the light transmitted without being diffracted by said computer generated hologram.

4. The apparatus according to claim 1, wherein said light distribution forming unit includes:
a first lens array having a refractive power only in a direction which is perpendicular to the optical axis of said illumination optical system and is perpendicular to the scanning direction of the reticle; and
a second lens array having a refractive power only in the scanning direction of the reticle, and
an incidence surface of said second lens array is arranged at a position shifted from a plane conjugate to the surface to be illuminated.

5. The apparatus according to claim 1, wherein said light distribution forming unit is a lens array including a plurality of optical elements configured to illuminate different illumination areas on the reticle.

6. The apparatus according to claim 1, wherein said illumination optical system includes a condensing optical system configured to condense the light beam emerging from said light distribution forming unit, and
a spot diameter determined by aberration of said condensing optical system is not more than ½ of a difference between an upper side and a lower side of a trapezoidal light intensity distribution formed by said light distribution forming unit when said condensing optical system generates no aberration.

7. A device fabrication method comprising steps of:
exposing a substrate using an exposure apparatus according to claim 1,
performing a development process for the substrate exposed.
